(19) United States
(12) Patent Application Publication
(10) Pub. No.: US 2006/0177133 A1
(43) Pub. Date: Aug. 10, 2006

(54) Systems and methods for segmentation of volumetric objects by contour definition using a 2D interface integrated within a 3D virtual environment ("integrated contour editor")

(75) Inventor: Chia Wee Kee, (US)

Correspondence Address: KRAMER LEVIN NAFTALIS & FRANKEL LLP, INTELLECTUAL PROPERTY DEPARTMENT, 1177 AVENUE OF THE AMERICAS, NEW YORK, NY, 10036, US

(73) Assignee: Bracco Imaging, s.p.a., Milano (IT)

(21) Appl. No.: 11/288,576

(22) Filed: Nov. 28, 2005

Related U.S. Application Data
(60) Provisional application No. 60/631,201, filed on Nov. 27, 2004.

(51) Int. Cl. G06K 9/34

(52) U.S. Cl. 382/173

(57) ABSTRACT

Systems and methods for a fully integrated contour editor are presented. In exemplary embodiments of the present invention a 2D interface which allows a user to define and edit contours on one image slice of the data set at a time is provided along with a 3D interface which allows a user to interact with the entire 3D data set. The 2D interface and the 3D interface are fully integrated, and contours defined or edited within the 2D interface are simultaneously displayed in the appropriate location of the 3D data set. The 2D contour can be created and edited with various readily available tools, and a region of interest indicated within the 3D data set causes the relevant 2D slice to be displayed in the 2D interface with an indication of the user selected area of interest. In exemplary embodiments of the present invention, systems can automatically generate contours based on user definition of a top and bottom contour, and can implement contour remapping across multiple data sets.

### CROSS-REFERENCE TO RELATED APPLICATIONS

This application claims the benefit of U.S. Provisional Patent Application No. 60/631,201, filed on Nov. 27, 2004. The disclosure of said provisional patent application is hereby incorporated herein by reference as if fully set forth.

### TECHNICAL FIELD

This application relates to the interactive visualization of 3D data sets, and more particularly to the segmentation of objects in 3D data sets by defining various 2D contours.

### BACKGROUND OF THE INVENTION

The ability to segment various anatomical objects from a given set of medical image data is an important tool in the analysis and visualization of various pathologies. Various conventional approaches have been implemented to automate this process. They have generally yielded good results as concerns the automatic segmentation of anatomical structures that are well defined and isolated. However, this easily segmented type of anatomical structure is not always available. Frequently, anatomical structures are spatially linked to other structures with similar characteristics making the segmentation decision more difficult. In such situations, automatic segmentation may not yield accurate results due to the inherent difficulties in being able to automatically distinguish one structure from a similar adjacent structure.

One possible solution to the above problem is to include user input in the segmentation process. This can be done, for example, by allowing a user to manually define regions to be segmented or, more precisely, to define the borders between a desired object and its surroundings. Such regions and/or their borders are also known as contours. By inputting contour information on various 2D slices of a set of medical image data, it is possible to segment a volume object based on the boundaries of user specified contours. As manual tracing can be tedious, semi-automatic approaches, such as contour detection, can be included to make such contour definition easier. Although a manual contouring process can take more time than a corresponding automatic process, it can provide a user with full flexibility and control in the segmentation of volume objects, which might otherwise be impossible to achieve using a purely automatic process.

Thus, there are various conventional contour editing software packages available. These programs attempt to provide tools that can assist a user to define contours. Generally, a user is presented with a 2D interface in which various slices of the volume object can be selected and viewed. Contours can then be drawn on the image slices themselves. However, such an interface is severely limited, because in many situations the user himself may not be able to accurately distinguish the various anatomical structures based on viewing a single slice image. In such cases a user needs to scroll through a few of the image slices to gain an accurate perspective of the anatomical structure in its real world context.

Some conventional software tries to overcome this limitation by providing a toggle mode that allows a user to switch between a 2D image slice view and a 3D volumetric object view. Others have separated the display screen into various windows, and try to show the 2D and 3D views simultaneously in such different windows. Although such a paradigm can aid a user in the visualization of the data, it does not provide a seamless way of defining contours and concurrently interacting with a 3D volumetric object. To interact in 2D or 3D, a user can only operate within specific defined windows. Furthermore, the tools provided by these software programs focus mainly upon the definition of the contours in 2D and do not facilitate interaction with the 3D object itself.

In an attempt to lessen a user's burden in defining contours, such conventional software sometimes also provides various tools that try to automatically detect such contours based on user inputs. However, these tools normally require a user to set and tweak multiple parameters to achieve accurate results.

What is needed is an improved method of segmenting 2D contours of a 3D object within an integrated interactive 3D visualization manipulation and editing environment.

### SUMMARY OF THE INVENTION

Systems and methods for a fully integrated contour editor are presented. In exemplary embodiments of the present invention a 2D interface which allows a user to define and edit contours on one image slice of the data set at a time is provided along with a 3D interface which allows a user to interact with the entire 3D data set. The 2D interface and the 3D interface are fully integrated, and contours defined or edited within the 2D interface are simultaneously displayed in the appropriate location of the 3D data set. A 2D contour can be created and edited with various readily available tools, and a region of interest indicated within the 3D data set causes the relevant 2D slice to be displayed in the 2D interface with an indication of the user selected area of interest. In exemplary embodiments of the present invention, systems can automatically generate contours based on user definition of a top and bottom contour, and can implement contour remapping across multiple data sets.

### BRIEF DESCRIPTION OF THE DRAWINGS

FIG. 1 depicts a single integrated contour editing environment according to an exemplary embodiment of the present invention;

FIG. 2 depicts an exemplary definition of a contour in point mode using an exemplary point tool according to an exemplary embodiment of the present invention;

FIG. 3 depicts the result of an exemplary automatic contour detection function operating on the points specified by a user shown in FIG. 2 according to an exemplary embodiment of the present invention;

FIGS. 4A-4B depict editing of an exemplary existing contour using a trace tool according to an exemplary embodiment of the present invention;

FIG. 5 depicts editing of the exemplary contour back in point mode according to an exemplary embodiment of the present invention;

FIG. 6 depicts a screenshot of an exemplary contour editor tool and interface showing all available functions and tools according to an exemplary embodiment of the present invention;

FIG. 7 depicts selection of an area of interest in a 3D object by a user according to an exemplary embodiment of the present invention;

FIG. 8 depicts immediate access to the slice corresponding to the area selected as shown in FIG. 7 according to an exemplary embodiment of the present invention;

FIG. 9 illustrates viewing of 4D contours within an exemplary integrated environment according to an exemplary embodiment of the present invention;

FIG. 10 according to an exemplary embodiment of the present invention;

FIG. 11 illustrates region definition for the exemplary data of FIG. 10 by placing contours according to an exemplary embodiment of the present invention;

FIG. 12 illustrates an exemplary control interface according to an exemplary embodiment of the present invention;

FIGS. 13-14 illustrate the use of an exemplary trace tool according to an exemplary embodiment of the present invention;

FIGS. 15-17 illustrate an exemplary pick tool according to an exemplary embodiment of the present invention;

FIGS. 18-20 illustrate an exemplary contour edit tool according to an exemplary embodiment of the present invention;

FIGS. 21-23 illustrate multiple slice contour detection according to an exemplary embodiment of the present invention;

FIGS. 24-26 illustrate an exemplary build suite of functions according to an exemplary embodiment of the present invention; and

FIGS. 27-30 illustrate an exemplary contour remapping function according to exemplary embodiments of the present invention.

It is noted that the patent or application file contains at least one drawing executed in color. Copies of this patent or patent application publication with color drawings will be provided by the U.S. Patent Office upon request and payment of the necessary fees.

It is also noted that some readers may only have available greyscale versions of the drawings. Accordingly, in order to describe the original context as fully as possible, references to colors in the drawings will be provided with additional description to indicate what element or structure is being described.

### DETAILED DESCRIPTION OF THE INVENTION

The present invention describes a new approach in contour definition workflow by providing a different paradigm in the way in which a user interacts, visualizes and defines the contours in the segmentation of a volume object. This can, in exemplary embodiments of the present invention, be achieved by redesigning various elements such as the user-interface, tool interactions, contour visualization, etc., as shall be described below. The combination of these elements can uniquely define the workflow in which a user performs segmentation of volume objects through contour definition.

In exemplary embodiments of the present invention, features of such a unique paradigm can be divided into the following elements:

1. Close integration of 2D and 3D interactions by uniquely defining a 2D interface within a 3D virtual environment where data input in one environment is simultaneously available in the other;

2. Interchangeability of tools that can be used in the definition and manipulation of contours;

3. Single point of activation for tools and functions;

4. Fast access to image slices using a 3D selection tool; and

5. Viewing of 4D data within the integrated environment.

These elements are next described in greater detail.

Close Integration of 2D and 3D by Uniquely Defining a 2D Interface Within a 3D Virtual Environment

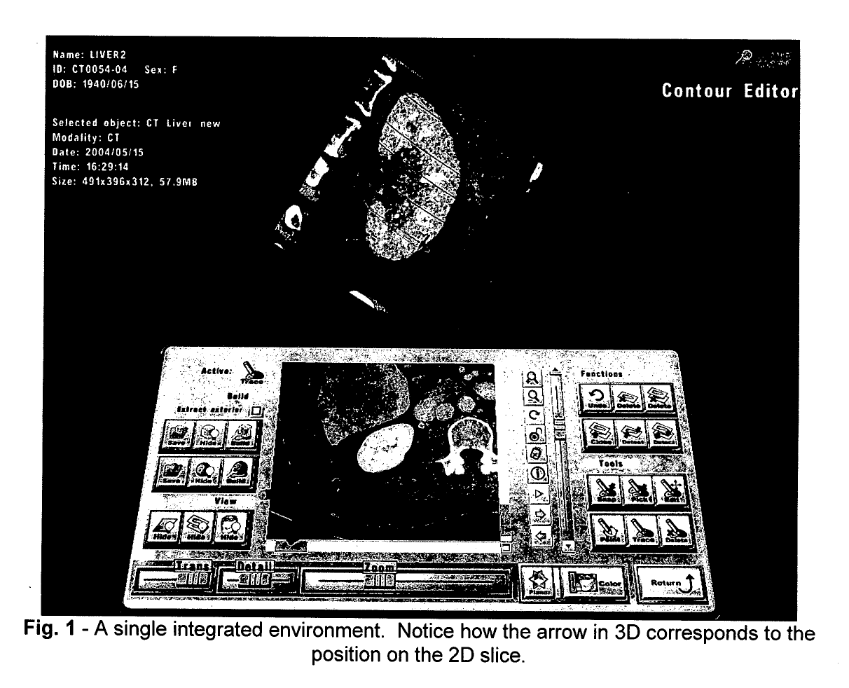

To allow seamless definition of contours and substantially simultaneous visualization of an object of interest and associated data in a 3D view, in exemplary embodiments of the present invention a 2D interface used for contour definition can be fully integrated within a single 3D virtual environment. Unlike existing software that uses a window approach to separate 2D interaction from 3D interaction in separate, and thus disconnected, windows, the present invention allows the definition of contours an individual image slices in 2D, and interaction and visualization of the corresponding volume data in 3D within a single integrated environment. An example screen shot of such an integrated environment is shown in FIG. 1.

Interchangeability of Tools that can be Used in the Definition of the Contours

To provide a seamless method for contour definition, in exemplary embodiments of the present invention, a contour defined by a user can be operated on using a variety of tools as a user may choose.

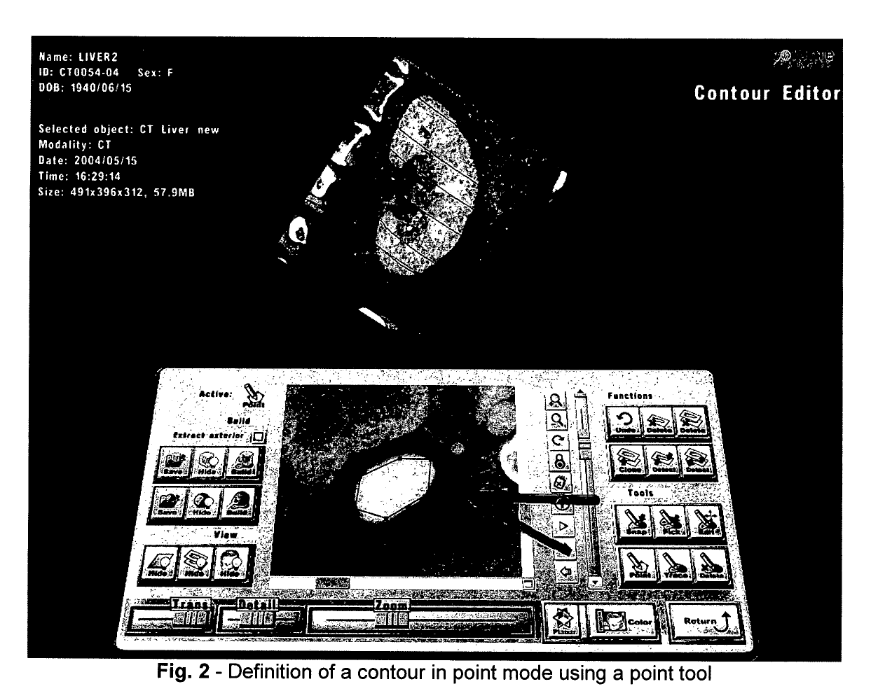

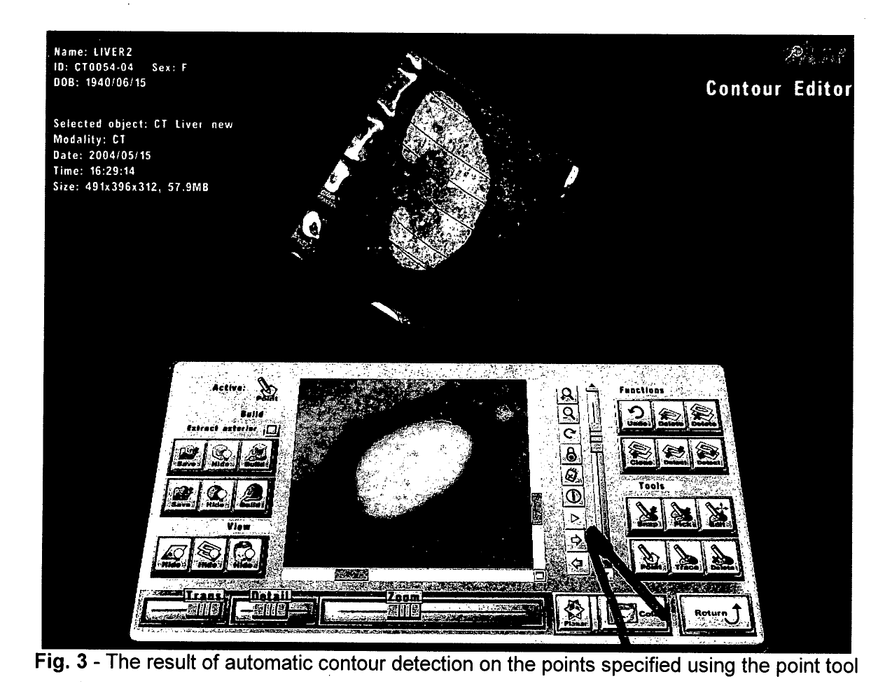

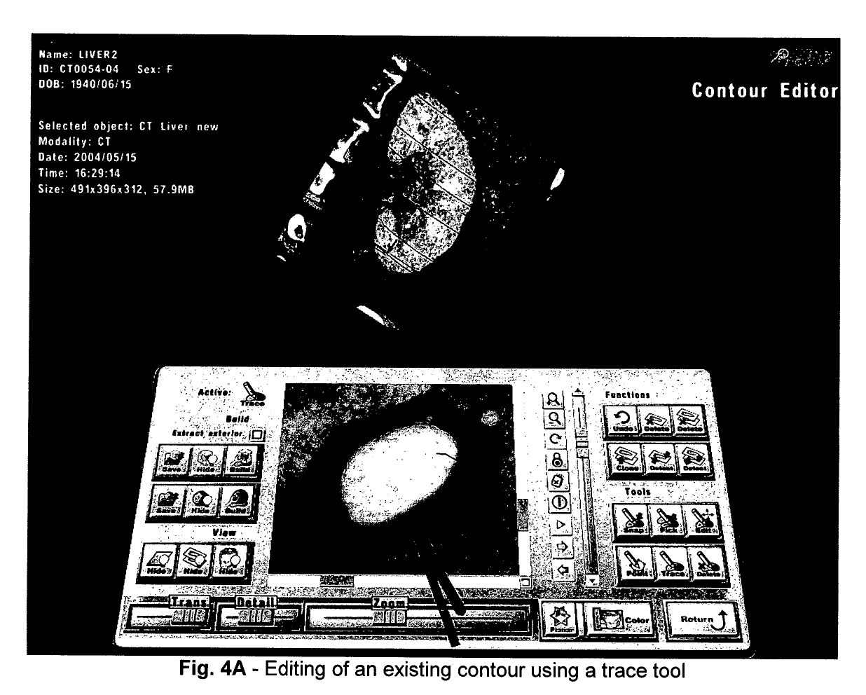

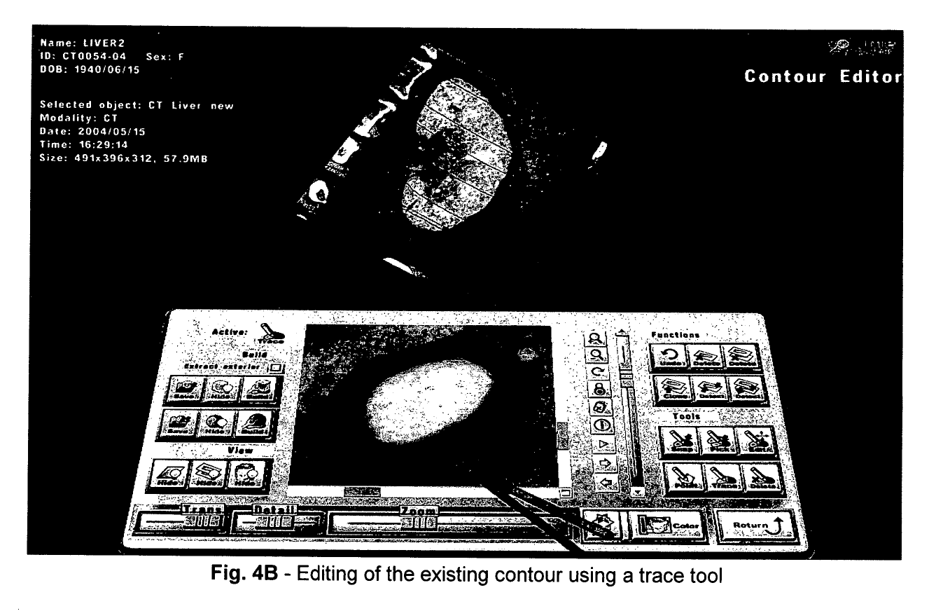

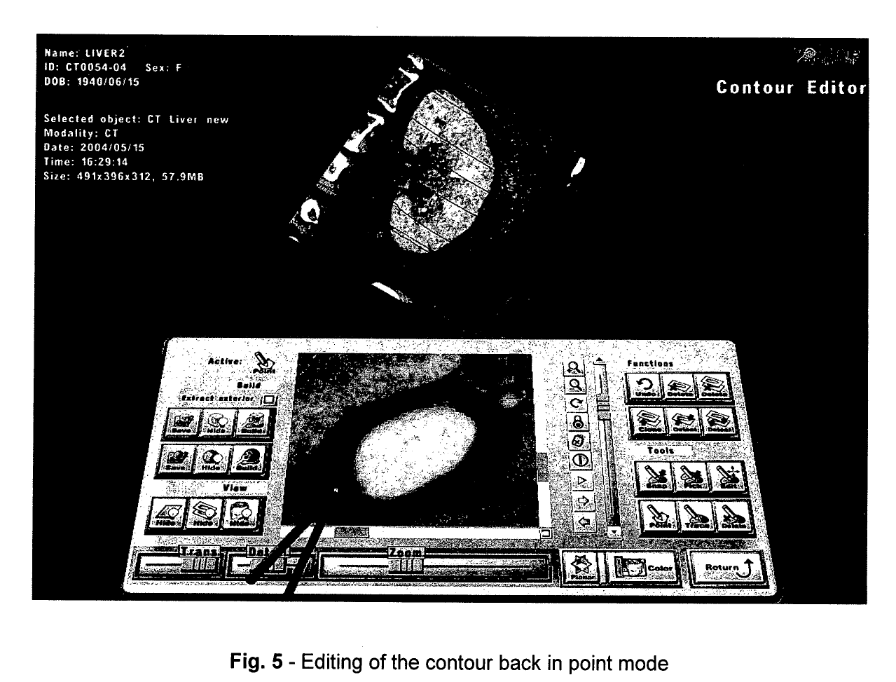

FIG. 2 depicts an exemplary definition of a contour in point mode using a point tool. FIG. 3 depicts the result of an exemplary automatic contour detection on points specified by a user with a point tool. FIGS. 4A-4B depict editing of an exemplary existing contour using a trace tool, and FIG. 5 depicts editing of an exemplary contour back in point mode again.

A Paradigm that Supports a Single Point of Activation for Tools and Functions

In exemplary embodiments of the present invention a user interface can, for example, support a paradigm in which all tools and functions can be activated by a single click. In such exemplary embodiments, there are no tools that require a user to either specify or define any parameters in order for it to be functional. All available tools and functions can be available directly on a user-interface through a single click. This is markedly different from most existing software in which it is common to use textboxes for user input and menus for function selection.

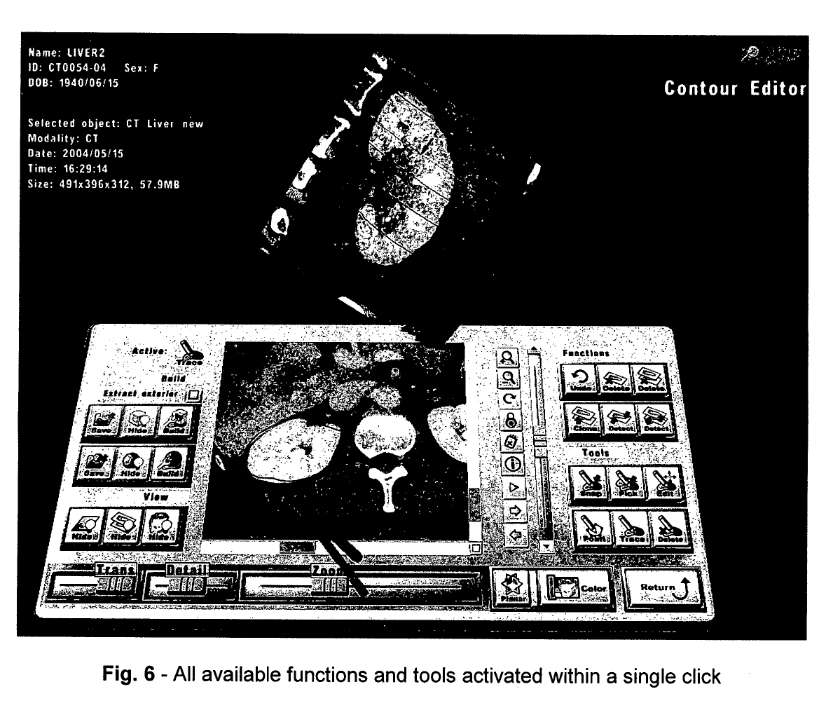

FIG. 6 depicts an example screenshot of an exemplary software implementation illustrating various functions and tools, all of which can activated within a single click, according to an exemplary embodiment of the present invention. This exemplary implementation is described more fully below.

Fast Access to Image Slice Using 3D Selection Tool

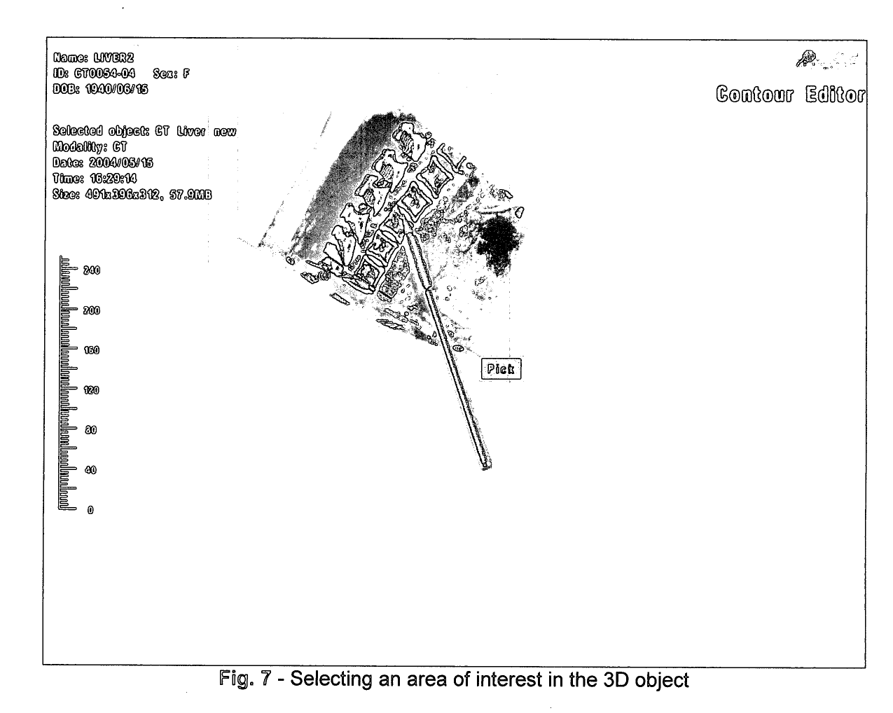

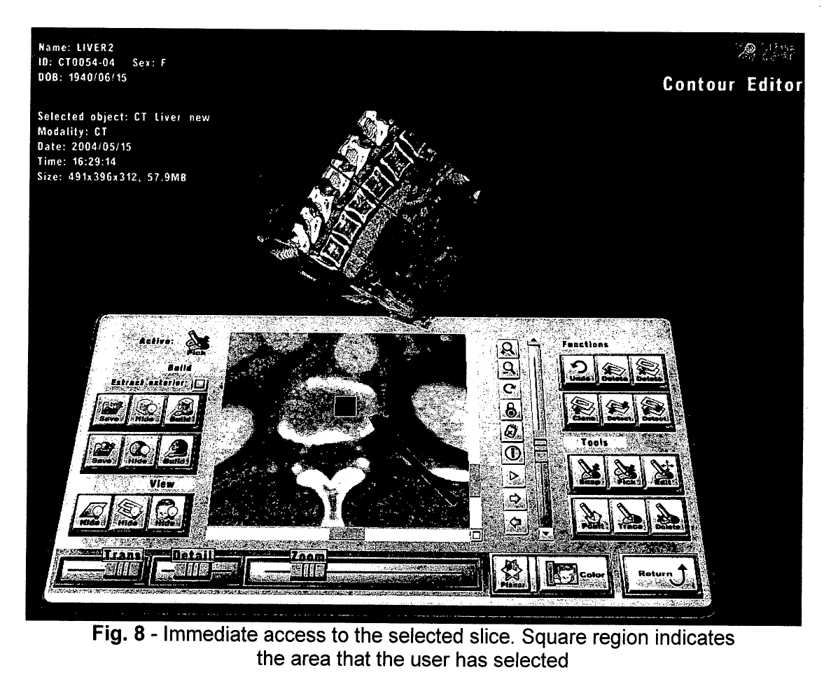

For the efficient definition of contours, it is important for a user to be able to go to slices containing a region of interest in a fast and efficient manner. Most conventional software utilizes sliders to allow a user to select the various slices in a volume object. This paradigm is inefficient as the user needs to go through various slices and at the same time interpret what he sees on the slice image. In exemplary embodiments of the present invention, a user can visualize data in 3D and pick a region of interest from such a 3D perspective. Then, a 2D interface can, in exemplary embodiments of the present invention, directly display the image slice that contains the region of interest specified by the user. This is depicted in FIG. 7, which depicts selecting an area of interest in the 3D object by a user. FIG. 8 depicts the corresponding immediate access to the selected slice that an integrated environment can provide. The square region in the 2D image slice of FIG. 8 (center region of the control panel) indicates the area that the user has selected, and the slice indicator in the volume has moved to the selected slice location within the volume.

Viewing of the 4D Data within the Integrated Environment

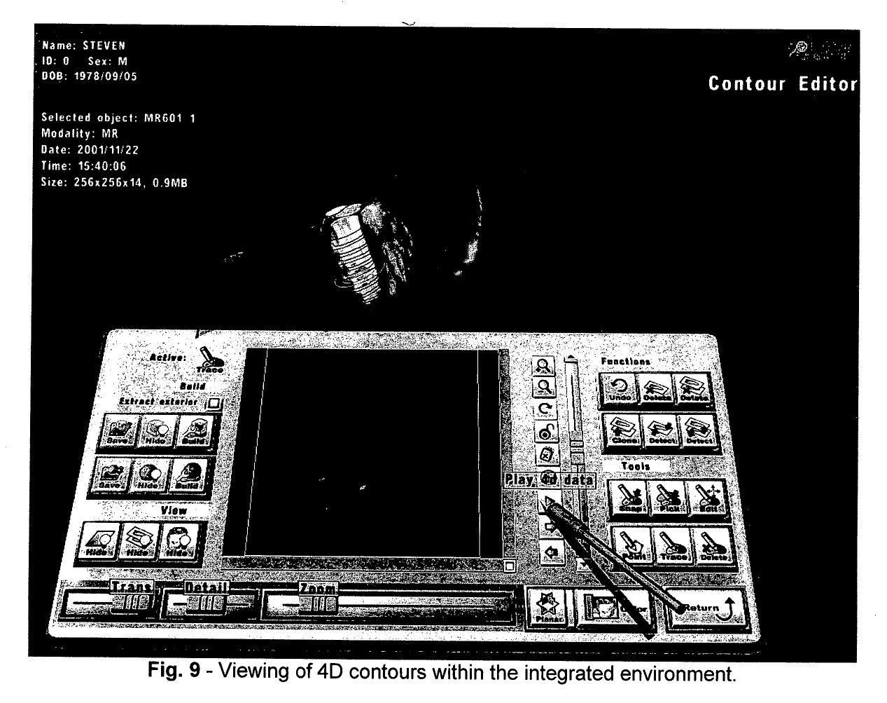

Most existing software supports only a non-integrated contouring of 3D data. In exemplary embodiments of the present invention, the contouring and visualization of 4D contours within a fully integrated environment are facilitated. Although the manual contouring of 4D data is tedious and not always performed, this element is important inasmuch as this feature allows for the importing and viewing of 4D contours that may be generated automatically in exemplary embodiments of the present invention. FIG. 9 illustrates an exemplary viewing of 4D contours within an integrated environment in an exemplary embodiment of the present invention.

Exemplary Systems

The present invention can be implemented in software run on a data processor, in hardware in one or more dedicated chips, or in any combination of the above. Exemplary systems can include, for example, a stereoscopic display, a data processor, one or more interfaces to which are mapped interactive display control commands and functionalities, one or more memories or storage devices, and graphics processors and associated systems. For example, the Dextroscope™ and Dextrobeam™ systems manufactured by Volume Interactions Pte Ltd of Singapore, running the RadioDexter software, or any similar or functionally equivalent 3D data set interactive display systems, are systems on which the methods of the present invention can easily be implemented.

Exemplary embodiments of the present invention can be implemented as a modular software program of instructions which may be executed by an appropriate data processor, as is or may be known in the art, to implement a preferred exemplary embodiment of the present invention. The exemplary software program may be stored, for example, on a hard drive, flash memory, memory stick, optical storage medium, or other data storage devices as are known or may be known in the art. When such a program is accessed by the CPU of an appropriate data processor and run, it can perform, in exemplary embodiments of the present invention, methods as described above of displaying a 3D computer model or models of a tube-like structure in a 3D data display system.

Given the functionalities described above, an exemplary system according to an exemplary embodiment of the present invention will next be described in detail.

Overview of an Exemplary Interface

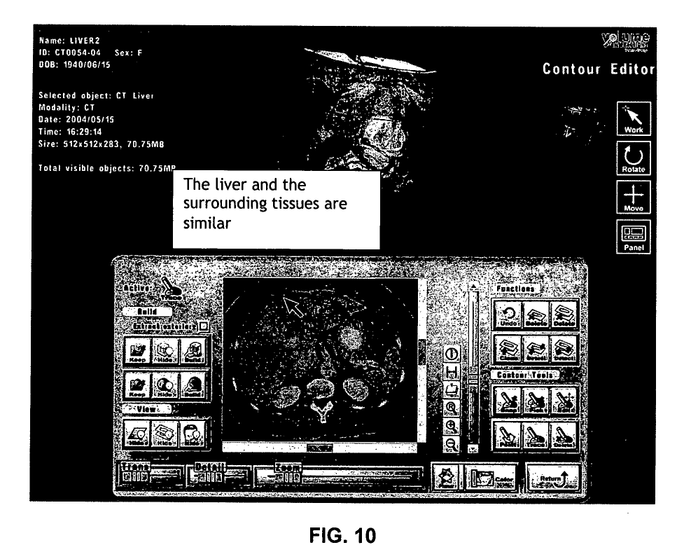

FIGS. 10 through 29 are screen shots of an exemplary interface according to an exemplary embodiment of the present invention implemented as a software module running on the Dextroscope™. Such an exemplary software implementation could alternatively be implemented on any 3D interactive visualization system.

In exemplary embodiments of the present invention a contour editor interface can, for example, be divided into 5 sections, which can, for example, work together to provide users with an integrated 2D and 3D environment that can facilitate easy segmentation of objects by defining contours. In most situations, the anatomy of interest is similar to its connecting tissues. Thus, it is often difficult to perform segmentation automatically, as noted above. Segmentation by contouring allows a user to input his domain knowledge into defining what is the desired region and what is the non required region, thus achieving greater control over the segmentation process.

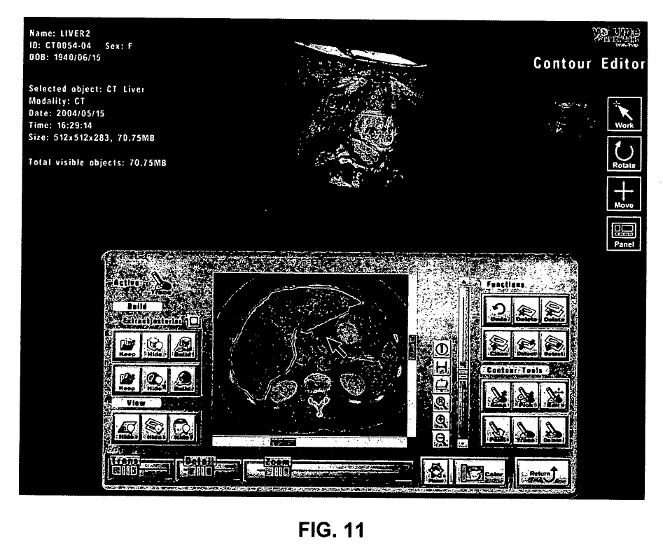

FIG. 10 shows a slice image of a liver and a volume containing the liver in which the liver and its surrounding tissues look similar, and FIG. 11 depicts how a user can accurately define regions by using contours.

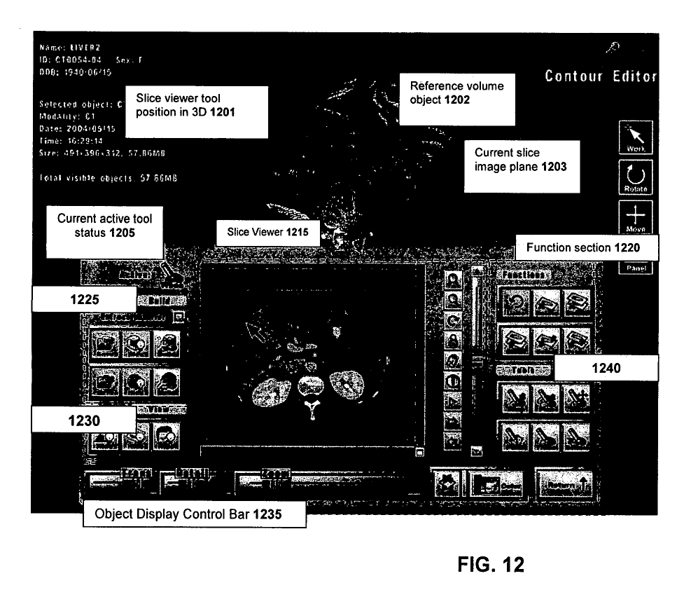

The 5 sections of the exemplary interface can, for example, consist of the following (index numbers refer to FIG. 12):

1. A Slice Viewer 1215;

2. Contour tools 1240;

3. A Functions section 1220;

4. A View section 1230; and

5. A Build section 1225.

These sections will next be described with reference to FIG. 12.

1. The Slice Viewer

In exemplary embodiments of the present invention, a slice viewer 1215 provides an interface that allows a user to view 2D images slices of the volumetric object. A user can navigate to other image slices by using a slider (shown on the right side of the image viewing frame). The slider can be used, for example, to cycle through the image slices in the data set. On the image slice itself, a user can perform zooming and panning to view different areas of the image. When a user moves a tool on the 2D image, the corresponding position is shown in the 3D environment. At the same time, as interacting with the image slice, a user can also manipulate the volume object using, for example, another control interface device, such as a left hand device. This allows the user to work simultaneously in both 2D and 3D.

2. Contour Tools

A contour tools section 1240 provides a user with a variety of useful tools that can work seamlessly together to allow a user to define and edit contours. There are six tools available in the tools section, as shown at 1240. These consist of, for example, a point tool, a trace tool, an edit tool, a pick tool, a snap tool and a delete tool, all as seen in tool section 1240. These tools are next described in detail.

2.1 Point Tool

A point tool allows a user to define contours by placing points on a slice image. Line segments can then be used to connect these points, resulting in a closed contour. Additionally, a user can add new points, can insert points into existing line segments on or can delete existing points.

2.2 Trace Tool

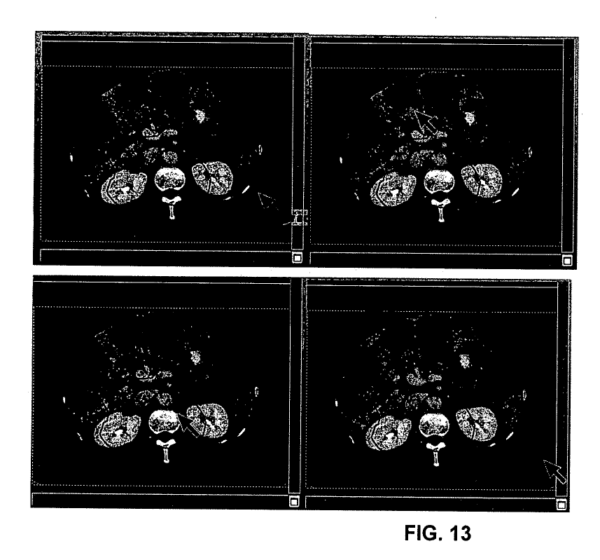

A trace tool can allow a user to, for example, define contours by drawing the contours in freehand. A user can also use this tool to edit existing contours, either by extending the contours around new regions or by removing existing regions from the area enclosed by the contours. This can also apply to contours that are drawn using the trace or other tools (e.g. point tool, etc). FIG. 13 illustrates how a trace tool can be used to extend an existing contour around additional regions, and

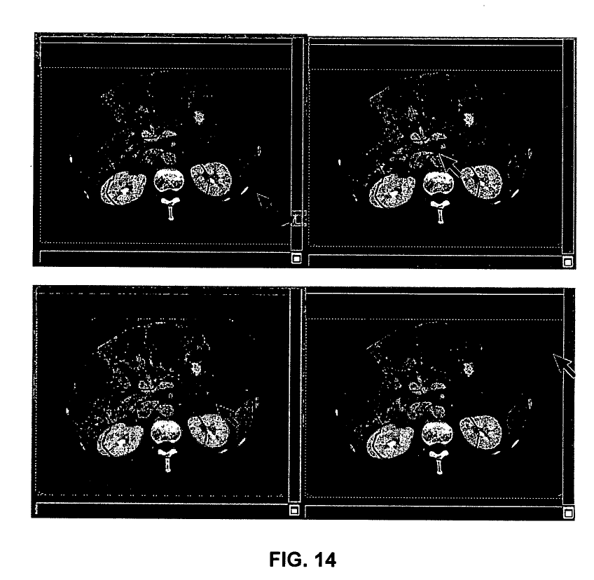

FIG. 14 illustrates the use of this exemplary tool to delete regions from an existing contoured region.

2.3 Delete Tool

In exemplary embodiments of the present invention, a delete tool can allow a user to remove existing contours on an image slice. In certain situations, there may be more than one contour on the slice image. The delete tool allows the removal of individual contours by allowing the user to pick the contour to be removed.

2.4 Snap Tool

In exemplary embodiments of the present invention, a snap tool can allow a user to perform contour tracing semi-automatically by using a livewire. To do this a user can define seed points on an image slice. As the user moves the snap tool, a trace line can automatically snap to the assumed edges of the region in the image slice, making it easier for a user to define the contours. This is an example of computer assisted contouring.

2.5 Pick Tool

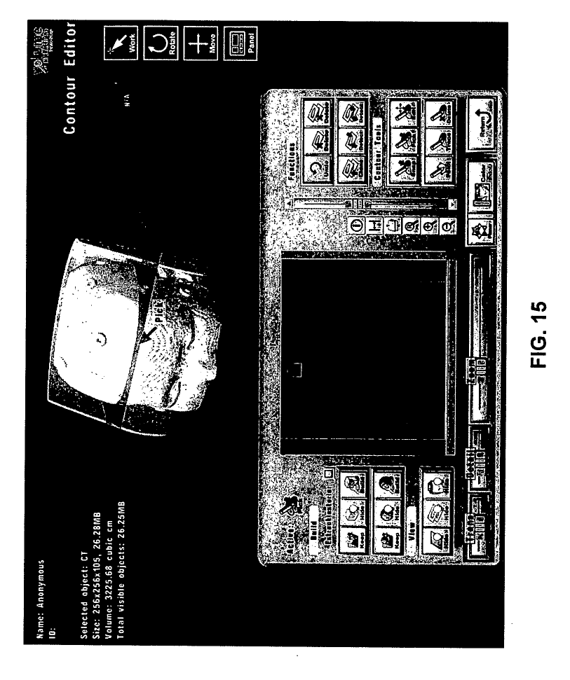

In exemplary embodiments of the present invention, a pick tool can allow a user to quickly access any slice image by using the tool to pick a point in the 3D space. This is most useful inasmuch as sometimes an object of interest can be more easily seen on the 3D object rather than on a corresponding image slice itself. By clicking on a point of interest in the volume (an exemplary pick point 1510 is shown in FIG. 15), the corresponding region on the 2D image slice can be shown (seen in FIG. 15 as light square in the top center of the 2D slice). The pick tool can also be used, for example, to pick existing contours in 3D, providing a fast access to select existing contours for editing.

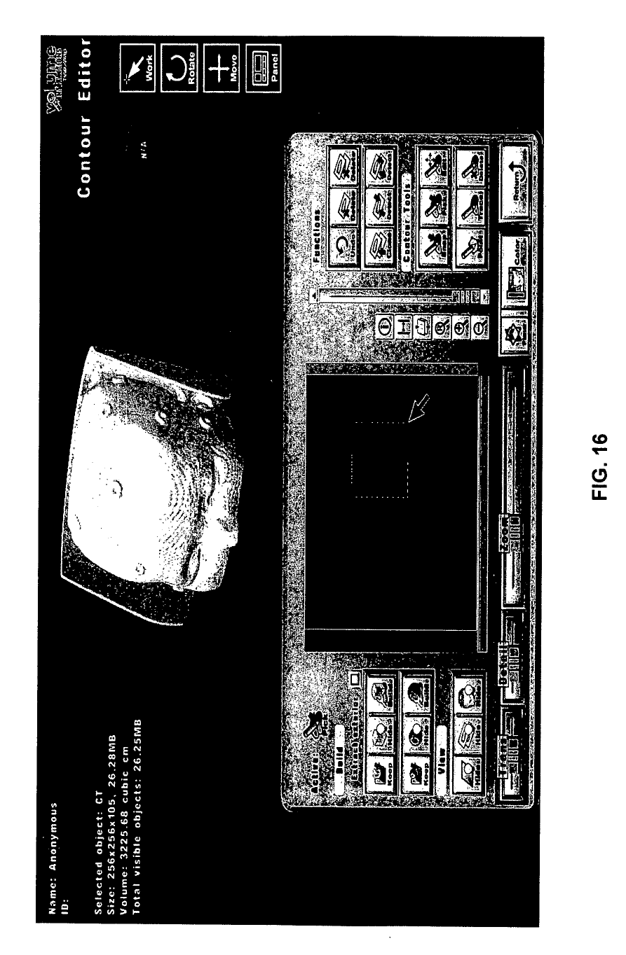

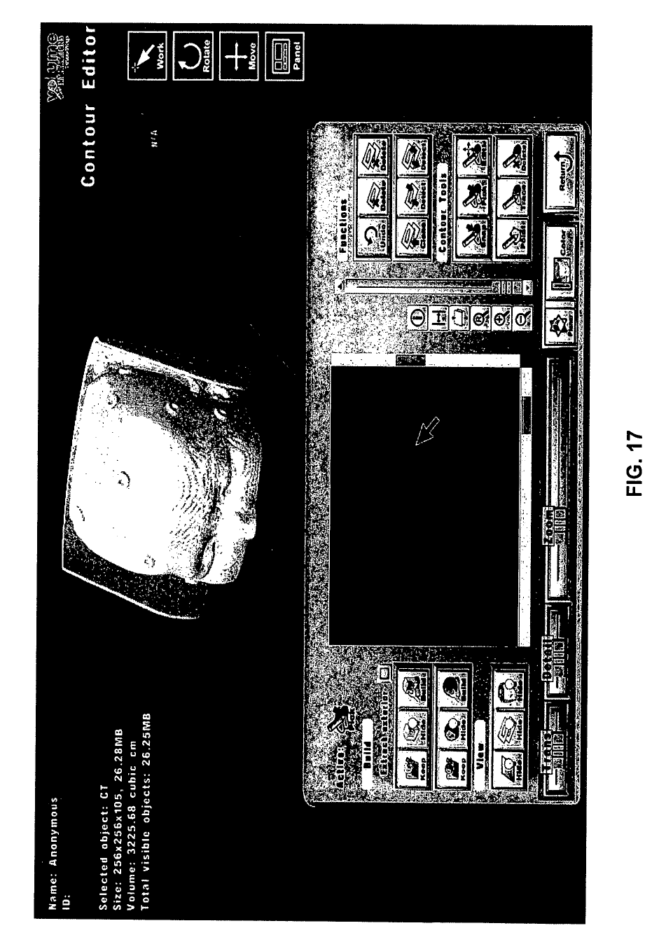

As noted, FIG. 15 illustrates an exemplary pick point in 3D being shown on the corresponding 2D image slice below. In exemplary embodiments of the present invention, a pick tool can also allow a user to define a region on an image slice and zoom in to the defined region in the corresponding 3D volume. FIG. 16 illustrates defining an area of interest (note dotted line square at top right of 2D slice), and FIG. 17 illustrates zooming in on the defined area of interest

2.6 Edit Tool

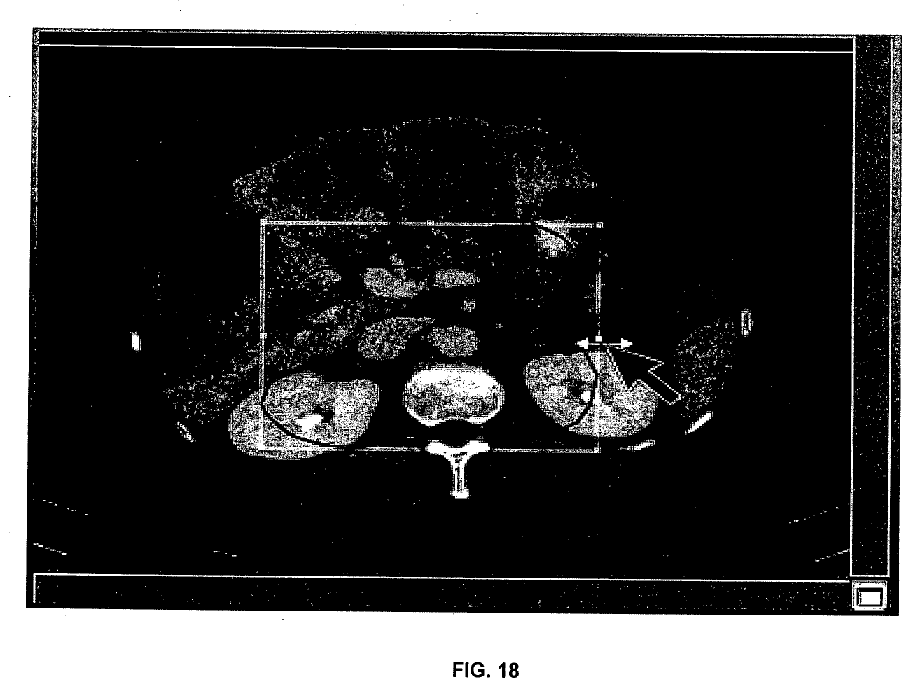

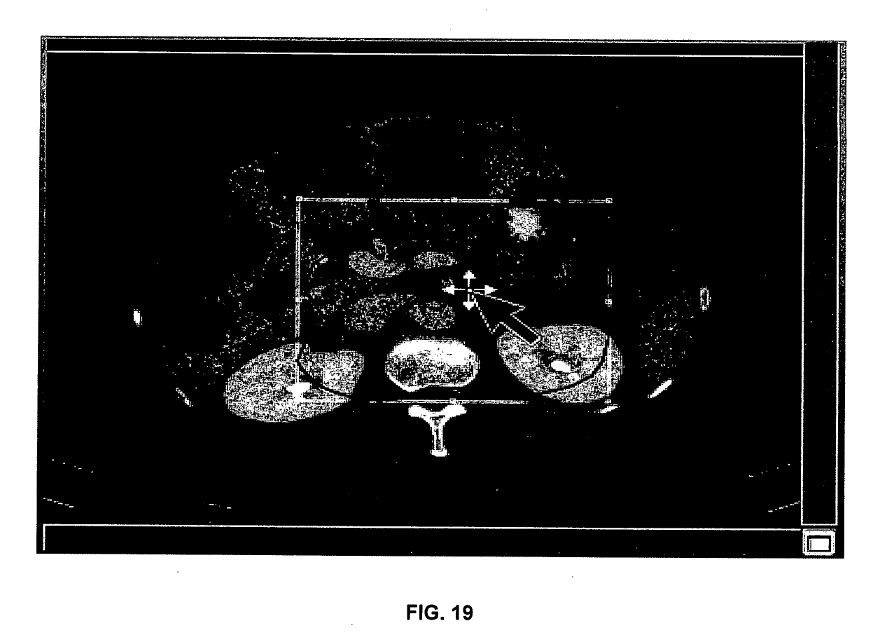

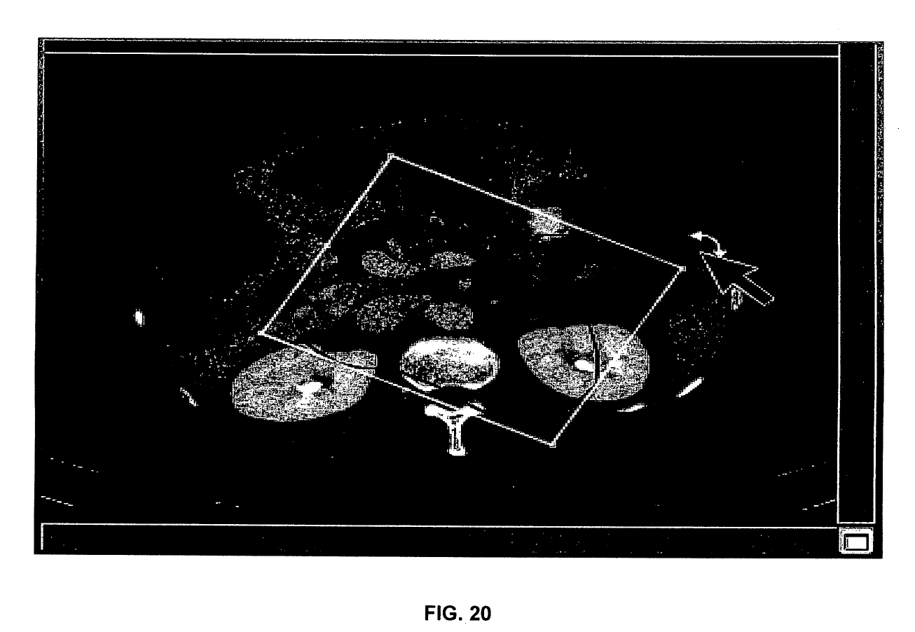

In exemplary embodiments of the present invention, an edit tool can allow a user to edit and modify existing contours by providing key control points on the bounding box of a contour. By adjusting these key control points a user can, for example, control the placement, size and orientation of a contour. FIG. 18 illustrates performing scaling of a contour, FIG. 19 illustrates performing moving of the contour, and FIG. 20 illustrates performing a rotation of the contour.

3. Function Section

In exemplary embodiments of the present invention, a Function Section (1220 in FIG. 12) can consist of various useful functions that can further assist a user in the segmentation process. In exemplary embodiments of the present invention, a Function Section can, for example, consist of six functions. The six functions can, for example, comprise clone, single slice contour detection, multiple slice contour detection, single slice contour removal and multiple slice contour removal and undo function. These will next be described in detail.

3.1 Clone Function

When a user defines a contour on a slice and moves to a next slice to define another contour, it is likely that the new contour will be similar to the previously drawn contour. This is because the outward contour of a volumetric object often does not change that radically with a small increment along one of its axes. Thus, instead of redrawing a similar contour on the new slice form scratch, a clone function can be used to create a new copy of an earlier contour by copying from an existing contour that is nearest to the current active slice. Thus a user can use the clone function to obtain a similar contour on the new slice and perform minor editing to get the exactly desired contour. This can improve the efficiency in defining of contours.

3.2 Single Slice Contour Detection

In exemplary embodiments of the present invention, single slice contour detection can be used to refine contours drawn by a user. A user can provide an approximation of the desired contour. Based on an edge detection feature performed on the image slice and the contours drawn by the user (also known as the active contours) a “suggested” contour can be generated by the system that may better fit a user's intentions.

3.3 Multiple Slice Contour Detection

In exemplary embodiments of the present invention, a multiple slice contour detection function can be used to automatically detect contours on different slices. A user can define contours on two or more image slices. Based on the contours that the user defines, this function can, for example, automatically perform contour detection on intermediate image slices for which contours have not been defined. This is most useful, as a user does not need to manually define the contours for each slice. Even if the contours are not exactly what the user wants, it is more efficient for him to edit contours rather than manually define all contours manually.

Exemplary Pseudocode for Multiple Slice Contour Detection

In exemplary embodiments of the present invention, multiple slice contour detection can be implemented using the following exemplary pseudocode.
1. Create a copy of the contours defined by a user;
2. Group the contours into pairs. For example, if there are 3 contours, the first 2 contours are considered a pair. The second and the last contour can be considered as another pair. Thus the total number of pairs will be equal to N-1 where N is the number of user-defined contours.
3. Start processing with the first pair of contours. The first contour of the pair is also referred to as the top contour and the second contour of the pair is also referred to as the bottom contour.
4. The single slice contour detection function is applied to the 2 user defined contours in the pair.
5. The top contour is copied onto the next slice using the clone function. The reason for this is that normally the next image slice although different from the starting image slice, still may have a lot of similarity due the proximity of the slices. By applying single slice detection to the new clone contour, a better approximation of the desired contour can be formed. This new contour then becomes the “top” contour.
6. The bottom contour is copied onto the previous slice using the clone function, and a step similar to step 5 is performed.

7. Both Steps 5 and 6 are repeated until the contours meet at mid point.

8. Steps 3 to 7 are then repeated for other pairs of contours until all the pairs have been processed.

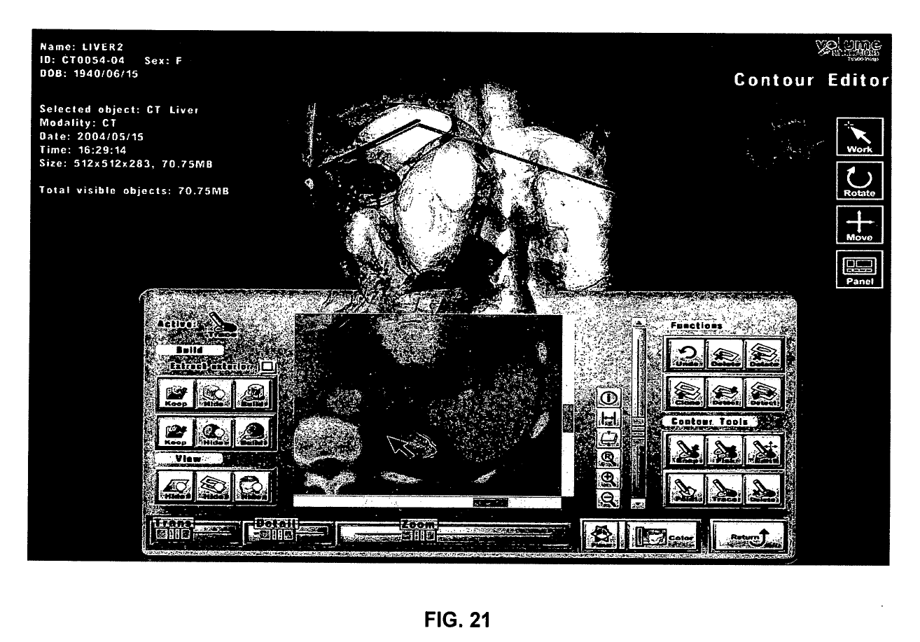

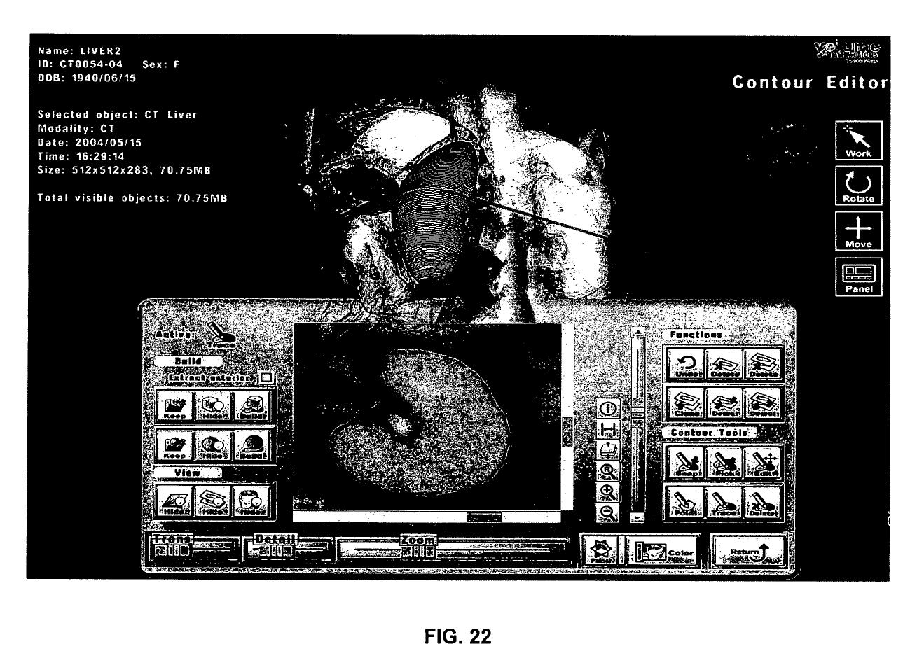

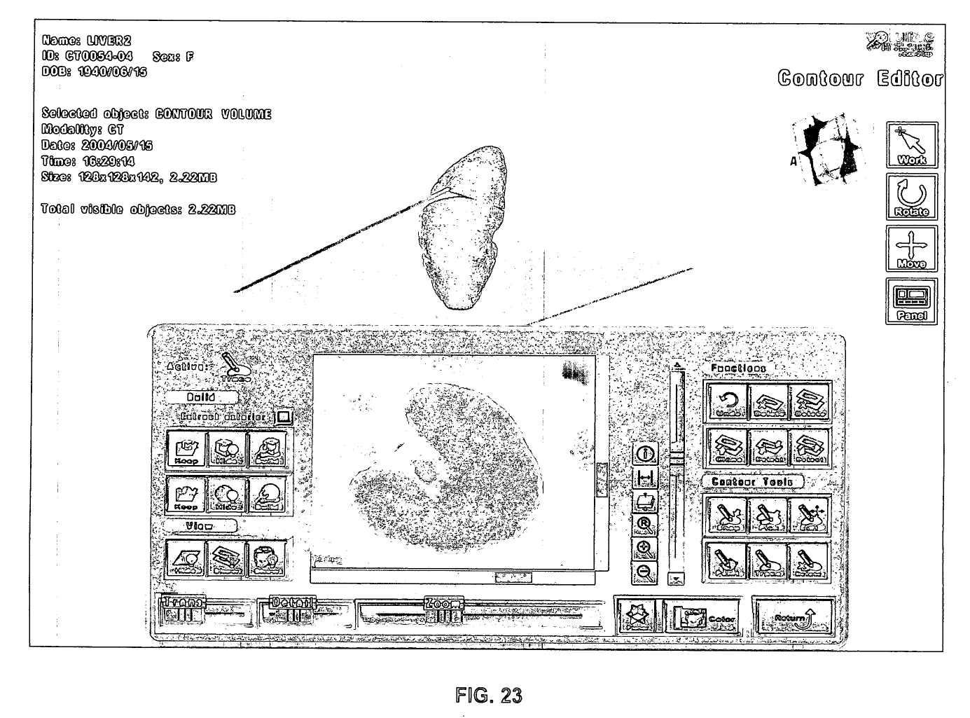

FIG. 21 illustrates exemplary initial contours defined at the top and bottom of an examplary kidney. The arrow in each of the slice viewer and the 3D volume points to the top contour. FIG. 22 illustrates exemplary new contours in intermediate slices that have been automatically created by an exemplary multiple slice contour detection function as described above according to an exemplary embodiment of the present invention. The slice viewer can display the contour corresponding to the plane displayed in the 3D volume. FIG. 23 illustrates the segmented kidney based on the contours that were detected.

3.4 Single Slice Contour Removal Function

In exemplary embodiments of the present invention, this function allows a user to remove all contours on the currently active slice.

3.5 Multiple Slice Contour Removal Function

In exemplary embodiments of the present invention, this function allows a user to remove all existing contours on all of the existing slices.

3.6 Undo Function

In exemplary embodiments of the present invention, an undo function can allow a user to undo the current action and restore the state of the contour editor to the state prior to the current action. It also allows a user to perform multiple undo operations.

4. The View Section

The view section, 1230 in FIG. 12, allows a user to select various viewing options. By selecting a particular viewing option, a user can focus on seeing only the objects that are of interest within the various stages in the contour editing process. In exemplary embodiments of the present invention, there are three view options available, viewing the plane, viewing the contours and viewing the volume itself.

4.1 Viewing the Plane

This view function allows a user to toggle between showing and hiding of the contour plane. The contour plane allows the user early identify the current slice image that is being viewed. However, there are situations in which a user may desire to just see the volume. Thus, this viewing option allows a user to either hide or show the contour plane as may be required.

4.2 Viewing the Contour

This view function allows a user to toggle between showing and hiding of the contours. A user may define a series of contours and segment an object based on such contours. Once the object is segmented, a user may desire to temporarily hide the contours so as to get a clearer view of the segmented object.

4.3 Viewing the Contour Volume

This view function allows a user to toggle between showing and hiding of the contour volume. A user may draw a series of contours and these contours may be inside the volume object and hence the user may not be able to see the contours. A user can hide the contour volume so as to view just only the contours.

5. Build Section

After a user has defined various contours, he may, for example, desire to segment the object based on the defined contours. The Build section (1225 in FIG. 12) provides a user with the ability to build a mesh object or a volume object based on defined contours.

5.1 Build Mesh Surface

This allows a user to build a mesh surface based on the defined contours.

5.2 Build Volume Object

This allows a user to build a volume object based on the defined contours.

Exemplary Pseudocode for Build Function

In exemplary embodiments of the present invention, a build function can be implemented using the following exemplary pseudocode.
1. Create a mesh surface based on a set of defined contours.
2. Determine the bounding box of the defined contours.
3. Create a new copy of the volume object based on the bounding box.
4. For each slice in the new copy, determine if it has a user-defined contour.
5. If there exists a user-defined contour, scan through the voxels in the slice image to check if they are inside the contour(s). If the voxels are not inside the contour, they are set to the value of 0 (indicate transparent).
6. If there does not exists a user-defined contour, create a contour by perform an intersection of the slice plane with the surface mesh. Scan through the voxels in the slice image to check if they are inside the newly created contour(s). If the voxels are not inside the contour, they are set to the value of 0 (indicate transparent).
7. Perform a smoothing operation on the segment volume object so that the segmented volume will have a smoother looking surface.
   5.3 Extract Exterior Option

In exemplary embodiments of the present invention, this function can provide an additional option when building a volume object. The default mode in the building of a volume object is to segment the volume object that is inside the contours and remove whatever scan data that lies outside of the contours. By selecting the extract exterior option, users can, for example, segment a volume object that is outside the defined contours (i.e., data inside the contours is removed instead).

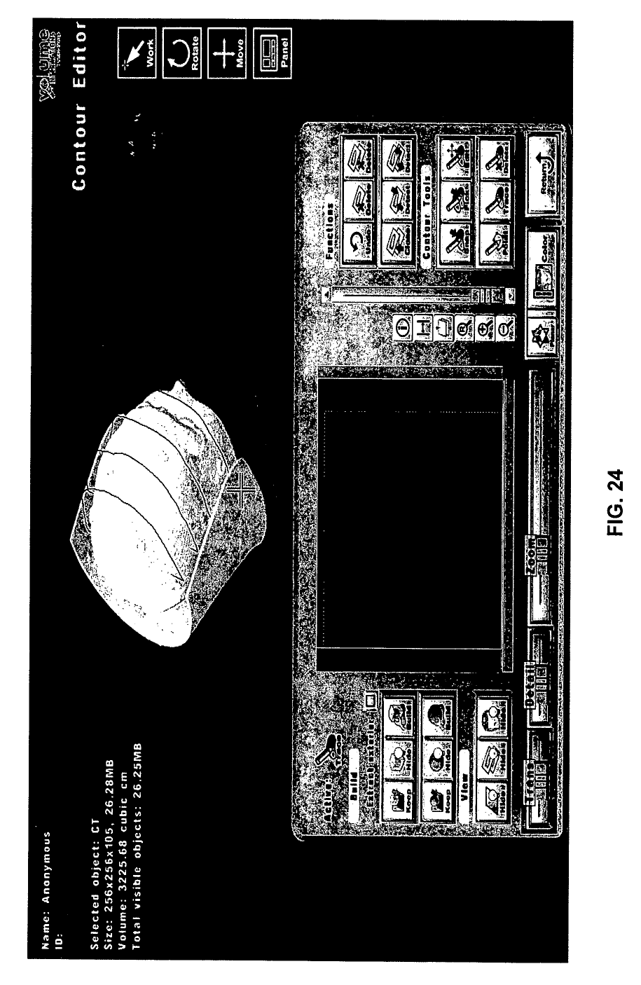

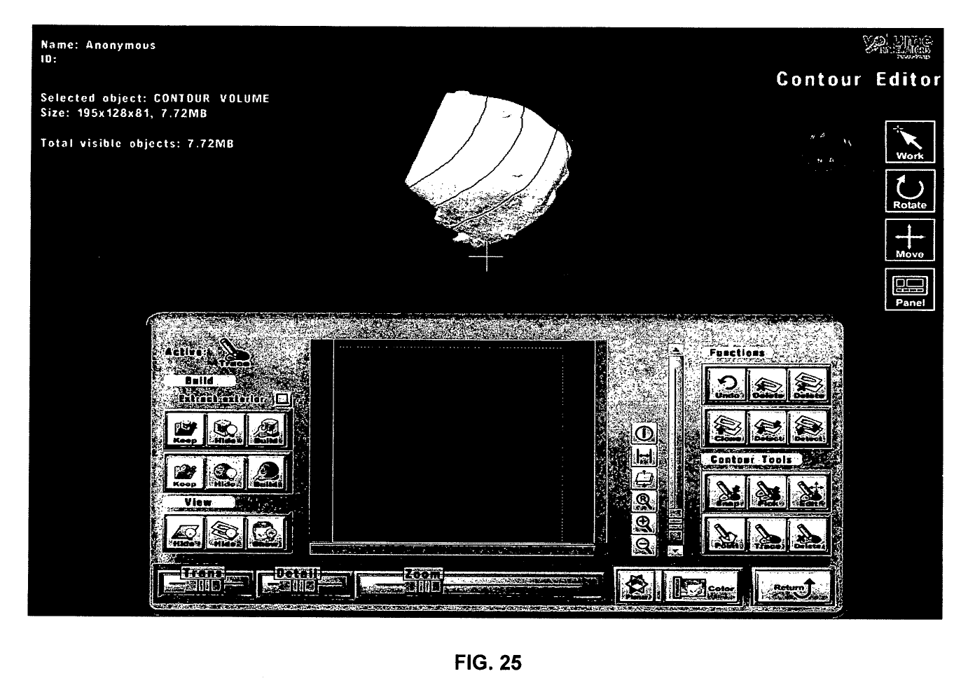

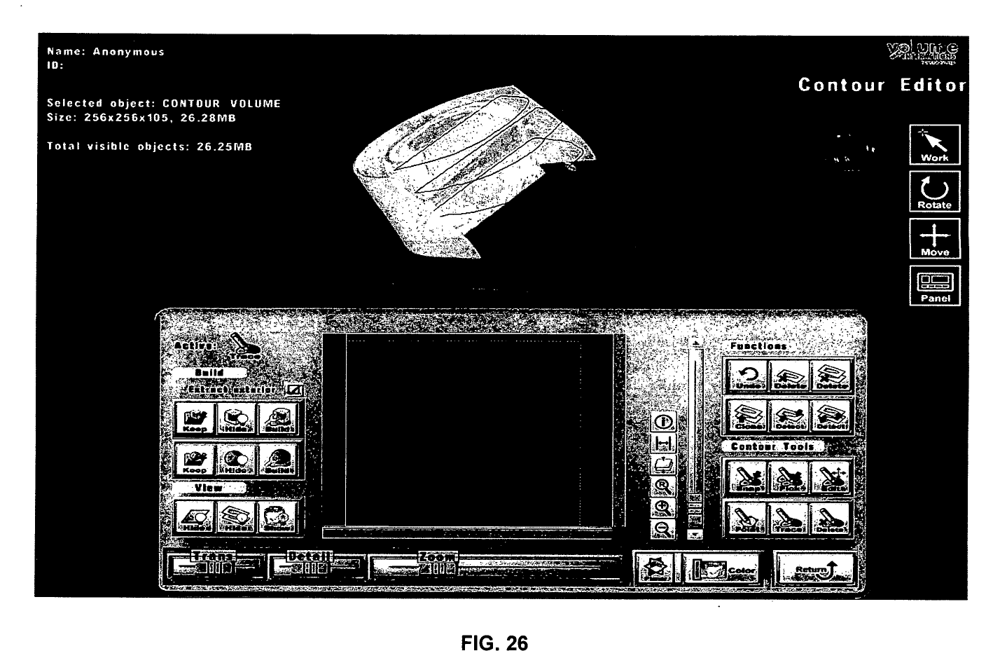

FIG. 24 illustrates exemplary initially defined contours within an object, FIG. 25 illustrates an exemplary segmented volume object using the default build option (extraneous scan data has been deleted), and FIG. 26 illustrates the results of a segmented volume object with the extract exterior option checked (scan data within area inside contours has been deleted).

5.4 Saving and View Function

In exemplary embodiments of the present invention, a user can choose to either hide or show a build mesh/volume object using the view options in the build section as described above. A user can also choose to keep the segmented mesh/volume object to be used for future sessions using the keep function (effectively a svae operation) in the build section.

Contour Remapping

In exemplary embodiments of the present invention, a user can define a set of contours on a certain volume object, such as, for example, a tumor shown on an MRI scan of a patient. The contours may be defined, for example, by using an axial view. A user may subsequently notice that a sagittal view provides a clearer view of the tumor. Instead of having to redefine the contours using the sagittal view, in exemplary embodiments of the present invention, a user can use the existing contours that have been defined in the axial view. The contour editor can remap existing contours and match them to a new desired view. Thus, using this functionality, a user can perform editing on the remapped contours, which can be significantly more efficient than redefining all of the contours manually.

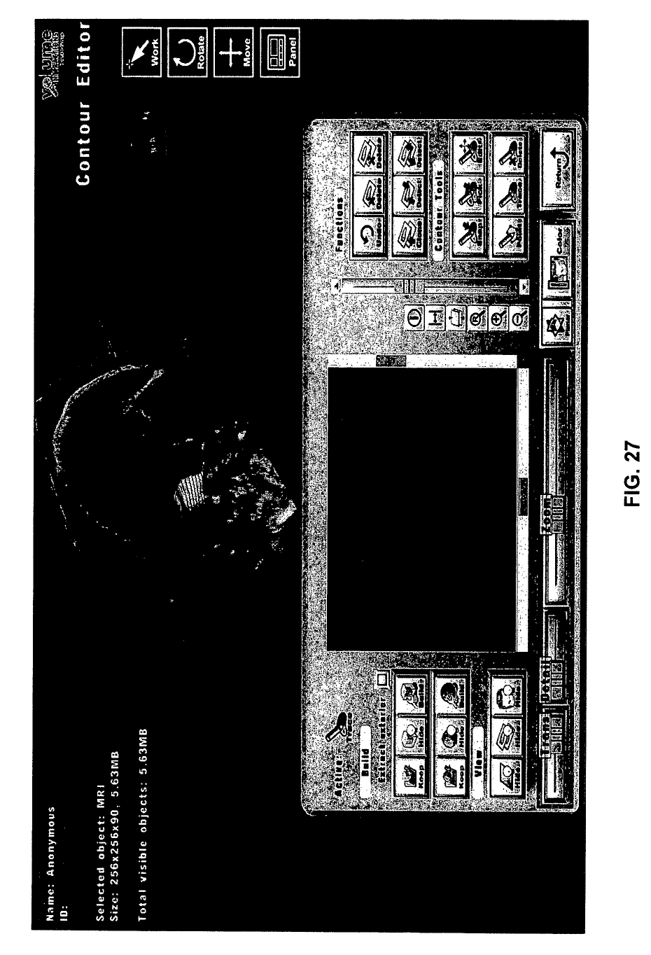

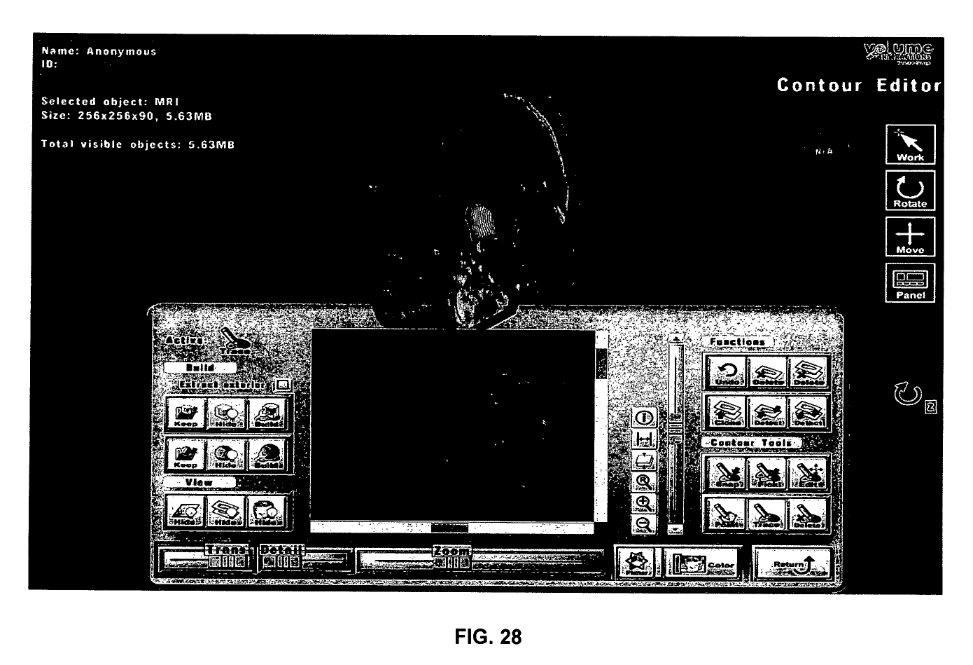

FIGS. 27-28 illustrate contour remapping. Thus, FIG. 27 shows exemplary contours defined in an axial view, and FIG. 28 shows related exemplary automatically remapped contours in sagittal view.

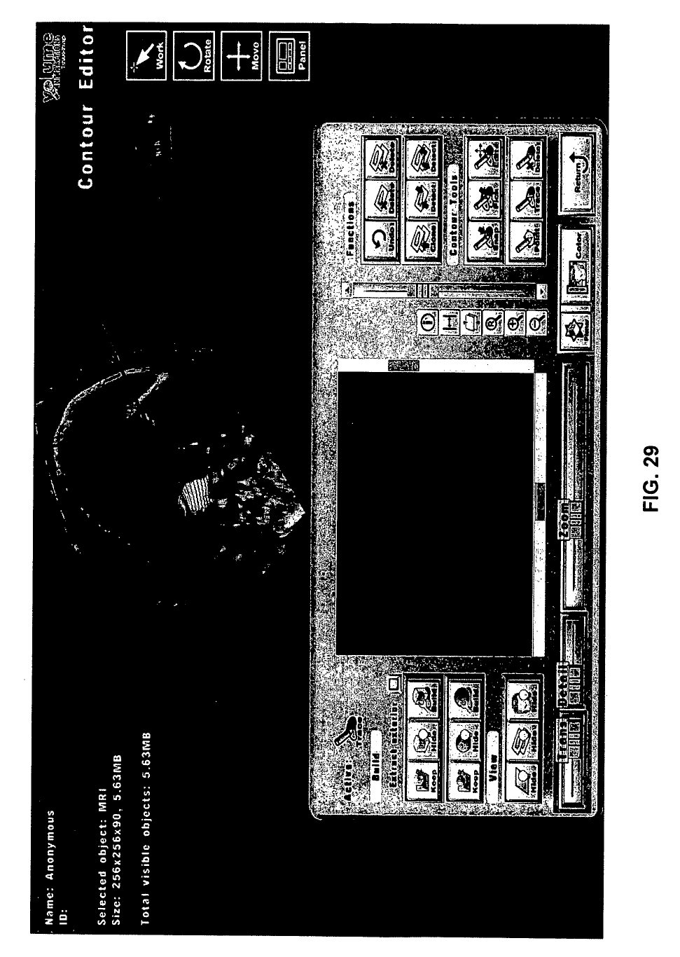

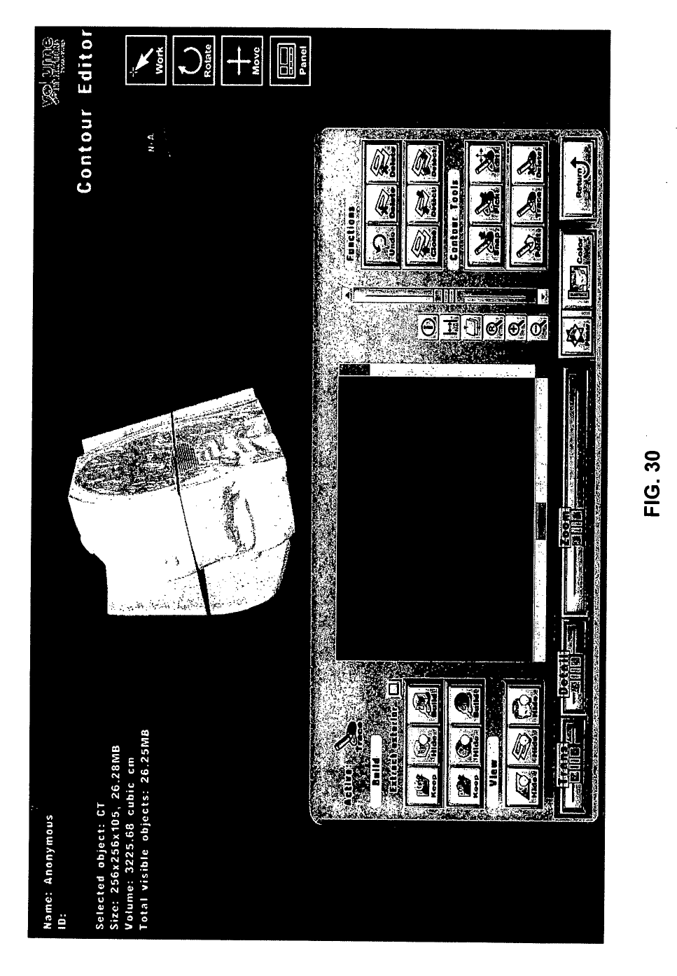

Besides remapping of contours to different views on the same volume data, in exemplary embodiments of the present invention, contours can also be remapped to other data of the same or different modality. For example, a user could have defined the contours of a tumor in slices of an MRI data set. Using the same contours, the contour editor can remap the contours to another co-registered data set (such as, for example, MRA data). Thus, a user can immediately see the region occupied by the contours as defined in one modality and its corresponding region in another modality. FIGS. 29-30 illustrate this function. This can provide a user with a multifaceted understanding of the volume being studied.

FIG. 29 depicts exemplary contours that define a tumor in an MRI data set. FIG. 30 depicts the remapping of the existing contours of FIG. 29 to another modality (e.g., CT data) according to an exemplary embodiment of the present invention.

Exemplary Pseudocode for Contour Remapping

In exemplary embodiments of the present invention, contour remapping can be implemented using the following exemplary pseudocode:
1. Build mesh based on existing defined contours;
2. When another view or modality is chosen, new contours are constructed by performing an intersection of the plane of the new view with the mesh surface;
3. The above intersection is performed for the various slices until the required number of contours can be constructed;
4. The number of contours to create is based upon the number of existing contours. For example, if the number of existing contours is 3, then the remapping process will try to create twice the number of existing contours. However, sometimes this may not be possible due to the fact the number of slices in a different view or data set may be different. For example, after mapping to another view, the number of slices for that view that is within the generated mesh may be 5. In such case, the maximum number of generated contours in the remapping process will be at most 5.
   Exemplary Systems

The present invention can be implemented in software run on a data processor, in hardware in one or more dedicated chips, or in any combination of the above. Exemplary systems can include, for example, a stereoscopic display, a data processor, one or more interfaces to which are mapped interactive display control commands and functionalities, one or more memories or storage devices, and graphics processors and associated systems. For example, the Dextroscope™ and Dextrobeam™ systems manufactured by Volume Interactions Pte Ltd of Singapore, running the RadioDexter™ software, or any similar or functionally equivalent 3D data set interactive visualization systems, are systems on which the methods of the present invention can easily be implemented.

Exemplary embodiments of the present invention can be implemented as a modular software program of instructions which may be executed by an appropriate data processor, as is or may be known in the art, to implement a preferred exemplary embodiment of the present invention. The exemplary software program may be stored, for example, on a hard drive, flash memory, memory stick, optical storage medium, or other data storage devices as are known or may be known in the art. When such a program is accessed by the CPU of an appropriate data processor and run, it can perform, in exemplary embodiments of the present invention, methods as described above of displaying a 3D computer model or models of a tube-like structure in a 3D data display system.

While the present invention has been described with reference to one or more exemplary embodiments thereof, it is not to be limited thereto and the appended claims are intended to be construed to encompass not only the specific forms and variants of the invention shown, but to further encompass such as may be devised by those skilled in the art without departing from the true scope of the invention.

What is claimed:

1. A method of segmenting an object from a 3D data set, comprising:
viewing one or more 2D slices of the 3D data set; and
defining a contour of the portion of the object in at least one of said 2D said slices,
wherein each contour entered is displayed in the current 2D slice and is also interactively displayed in relevant location within a 3D volume of the 3D data set.

2. The method of claim 1, wherein the 2D interface and the 3D interface are fully integrated, and data entered in one interface is substantially immediately available in the other.

3. The method of claim 1, wherein each contour can be edited using a variety of tools.

4. The method of claim 3, wherein said tools include snap, point, pick, edit, trace and delete.

5. The method of claim 3, wherein said editing tools are accessible by clicking on an icon on a virtual tool palette.

6. The method of claim 1, wherein a contour can be defined in a point mode, where a user sets a number of points and the contour is automatically detected therefrom.

7. The method of claim 1, wherein a contour once defined can be expanded via a trace tool, can have a portion deleted via a delete tool, or can be edited in point mode via a point tool.

8. The method of claim 1, wherein when a user indicates an area of interest in the 3D data set by selecting a point of interest in the 3D volume, the 2D slice containing said area of interest is immediately automatically displayed in the 2D interface with said area of interest contained in the 2D slice indicated.

9. A contour editor for use in an interactive display of a 3D data set, comprising:
a 2D interface which allows a user to define and edit contours within one slice of the data set at a time; and
a 3D interface which allows a user to interact with the entire 3D data set,
wherein the 2D interface and the 3D interface are fully integrated, and wherein
contours defined or edited within the 2D interface are simultaneously displayed in the appropriate location of the 3D data set.

10. The contour editor of claim 8, wherein a user can easily switch between the 2D interface and the 3D interface by a simple click on a physical interface or pointing of a cursor at a defined location of a display.

11. The method of claim 10, wherein the 2D interface also indicates the area within it that is within the region of interest selected by the user.

12. The method of claim 1, wherein contours created in one view can be automatically remapped to another view.

13. The method of claim 1, wherein contours created using data form one scan modality can be automatically mapped to another co-registered modality.

14. The method of claim 1, further comprising automatically generating contours in intermediate image slices based upon contours defined by a user at boundary image slices.

15. The method of claim 1, further comprising drawing on system intelligence to assist a user by semi-automatically defining contours.

16. The method of claim 15, wherein the system uses user defined contours and edge detection as inputs to a contour generation algorithm.

17. The contour editor of claim 8, wherein a user can view 4D contours.
